(19) United States
(12) Patent Application Publication
(10) Pub. No.: US 2007/0075826 A1
(43) Pub. Date: Apr. 5, 2007

(54) METHOD FOR MANUFACTURING CHIP RESISTOR NETWORKS

(76) Inventors: Chun-Tiao Liu, Hsinchu City (TW); Minhor-Hsiao, Hsin-Chu City (TW); Hung Ming Lin, Hsin-Chu City (TW); Peng Wen-Lung, Hsin-Chu City (TW); Liu Tzu Hau, Hsin-Chu City (TW)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/424,546

(22) Filed: Jun. 16, 2006

(30) Foreign Application Priority Data
Sep. 30, 2005 (TW) 094134379

(51) Int. Cl. H01C 1/012

(52) U.S. Cl. 338/309

(57) ABSTRACT

The present invention discloses methods for manufacturing chip resistor networks, which are free from the short circuit owing to electron migration of the silver electrodes. In one embodiment of the present invention, a barrier layer is formed to prevent the silver electrodes from electron migration. In another embodiment of the present invention, copper or nickel electrodes are formed to replace silver electrodes. These methods for manufacturing chip resistor networks are the ways to solve the short circuit caused by electron migration of the silver electrodes.

### BACKGROUND OF THE INVENTION

1. Field of the Invention

The present invention generally relates to a structure and a manufacture method of a chip resistor network, and more particularly to a structure and a manufacture method of a chip resistor network to prevent the electrodes from electron migration.

2. Description of the Prior Art

FIG. 1A to FIG. 1D show the top views of a conventional method for manufacturing a chip resistor network. First, as shown in FIG. 1A, by using thick film printing method a plurality of electrodes 102 is printed on an alumina substrate 100, and then a plurality of resistors 104 is printed on the alumina substrate 100, and both ends of each resistor 104 are separately connected to the paired electrodes 102, as shown in FIG. 1B. As shown in FIG. 1C, then a first glass protective layer is printed to cover the alumina substrate 100, part of the electrodes 102, and the resistors 104. By laser trimming, the resistance of the resistors 104 is adjusted within the preset range, and the laser-trimming area 107 will expose a part of metal, such as silver, etc. Then, a second glass protective layer 108 is printed to cover the alumina substrate 100, part of the electrodes 102, and the first protective layer 106 to protect the laser-trimming area 107, as shown in FIG. 1D. Then, the silver paste is pasted on the side-edges of the alumina substrate 100 to form termination electrodes. After the substrate 100 is broken into chips, the chips are electroplated with nickel and tin, and then a plurality of resistor networks is fabricated.

At present, the common trend of the electronics product is light, thin, short and small. The electronics product contains more components, and is shrunk to promote their function and efficiency. Certainly the chip resistor networks also cannot escape from this trend. Along with this trend, the resistors and electrodes inside the chip resistor networks become smaller, and the distance between adjacent electrodes is diminished. Because the resistors become smaller, the distance between the paired electrodes connected to two ends of each resistor also diminishes.

The material of the electrodes 102 on the aforementioned chip resistor networks is mostly silver. That is because cost of silver is much lower than that of gold, even though the conductivity of silver is merely inferior to that of gold. Because the distance between the adjacent electrodes 102 diminishes, the electron migration of the adjacent silver electrodes 102 happens easily. Therefore, if there is some moisture inside the chip resistor networks or bigger electric current passes during operation of the chip resistor networks, the short circuit occurs easily due to electron migration.

Besides, this is not the only path that the electron migration phenomenon happens on the silver electrodes 102 of chip resistor networks. Owing to the shrinkage of resistors 104, the distance between the paired silver electrodes 102 connected to both ends of the resistors 104 diminishes. This is another path that electron migration occurs on the paired electrodes 102 themselves. Furthermore, during manufacture of chip resistor networks, laser trim is performed to adjust resistance of resistors 104 to the requested value. The areas 107 on resistors 104 after laser trimming, called laser-trimming area, will expose silver. Owing to the shrinkage of the resistors 104, the distance between the exposed metal on laser-trimming area 107 and the silver electrodes 102 diminishes. The electron migration phenomenon occurs easily between the silver electrodes 102 and the laser-trimming area 107. This is further another path of electron migration.

Accordingly, it is urgent to solve the above-mentioned problem that the electron migration phenomenon occurs on electrodes during operation of chip resistor networks, owing to the shrunk chip resistor networks.

### SUMMARY OF THE INVENTION

In terms of the aforementioned difficulties, it is an object of the present invention to provide a method for manufacturing chip resistor networks, wherein a barrier layer is formed to completely cover the silver electrodes to prevent the short circuit due to electron migration between electrodes and laser-trimming areas.

Another object of the present invention is to provide a method for manufacturing chip resistor networks by using a low electron migration material to replace the original silver electrodes to solve the short-circuit problem caused by electron migration.

In terms of the aforementioned objects and according to one embodiment of the present invention, a method for manufacturing chip resistor networks is provided. A plurality of resistors connected to the paired electrodes is formed. A protective layer is deposited on part of resistors, and a barrier layer is deposited on the electrodes. A laser trim is performed to adjust the resistance of the resistors. Then, a second protective layer is deposited, and then after breaking the substrate a plurality of chip resistor networks is fabricated. According to this manufacture method mainly aimed at the chip resistor networks with silver electrodes, a barrier layer is formed to completely cover the electrodes to prevent the electrodes from electron migration.

Another embodiment of the present invention provides a method for manufacturing chip resistor networks by using low electron migration electrodes in place of the silver electrodes. First, a plurality of resistors is formed on the alumina substrate, and a first protective layer is deposited to cover part of the resistors. Then, by sputter deposition and evaporation deposition a seed layer is formed to completely cover the alumina substrate, the resistors and the first protective layer. Next, by photolithography the seed layer is exposed on the predetermined electrode areas. The electrode layer composed of nickel or copper is deposited. The photoresist is removed. The seed layer is etched so that the electrodes are fabricated. Alternatively, a metal mask is used to cover the alumina substrate, and only the predetermined resistor contact areas are exposed. Next, by sputter deposition or evaporation deposition an adhesive layer is formed to the predetermined electrode areas, and furthermore an electrode layer is formed to complete the fabrication of the electrodes. Then, after the laser trim is performed to adjust the resistance of the resistors, a second protective layer is deposited. Then, the substrate is broken into resistor-network units. Because the material of the electrodes is not silver but low electron-migration material, during operation of chip resistor networks the short circuit will not happen by electron migration phenomenon.

### BRIEF DESCRIPTION OF THE DRAWINGS

FIG. 1A to FIG. 1D show the top views of a conventional method for manufacturing a chip resistor network.

FIG. 2A to FIG. 2E show the top views of a method for manufacturing a chip resistor network according to one embodiment of the present invention.

FIG. 3A to FIG. 3H show the top views of a method for manufacturing a chip resistor network according to another embodiment of the present invention.

FIG. 4A to FIG. 4G show the top views of a method for manufacturing a chip resistor network according to further another embodiment of the present invention.

FIG. 5A to FIG. 5F show the perspective views of a fabrication method of termination electrodes according to the present invention.

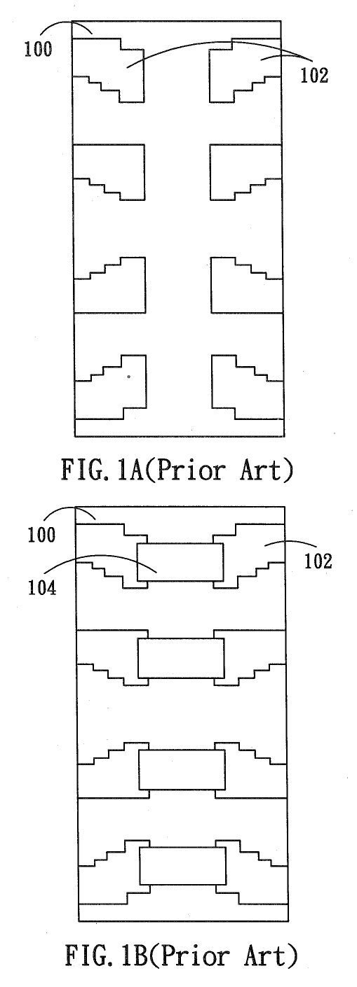

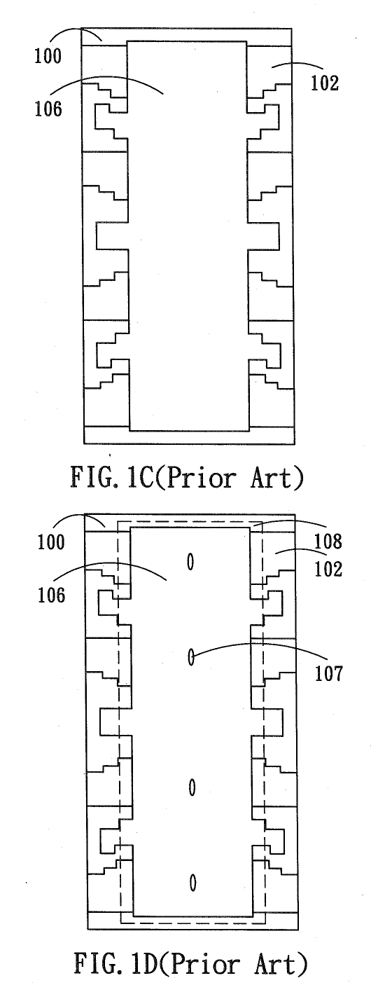

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

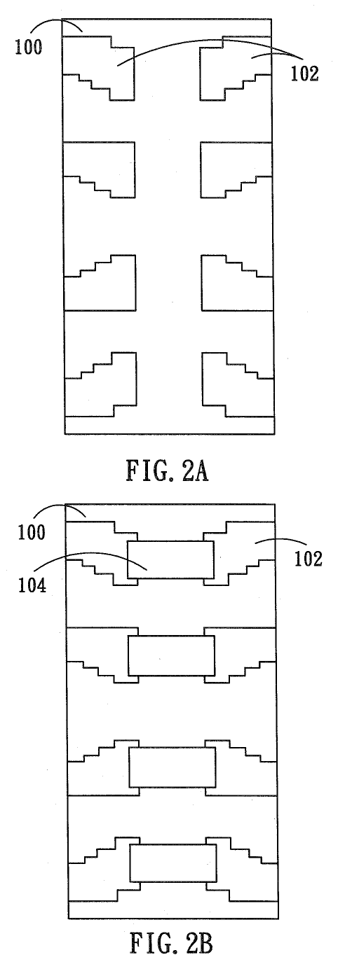

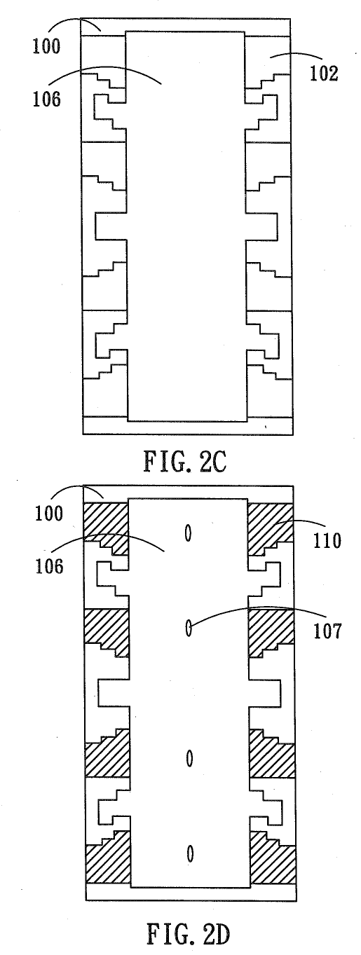

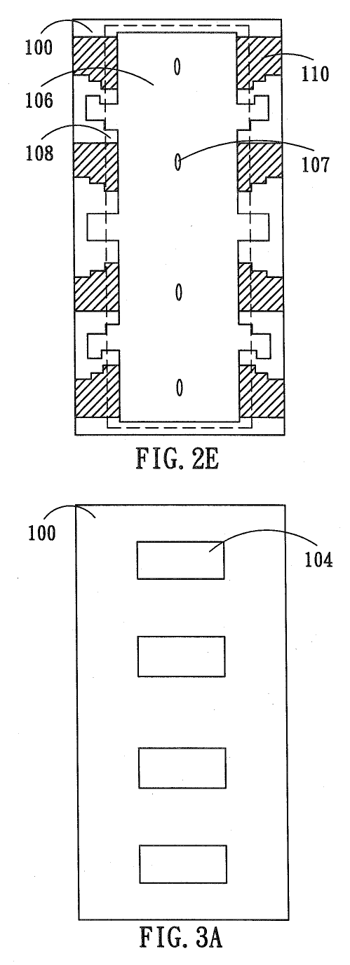

FIG. 2A to FIG. 2E illustrate top views of a method for manufacturing a chip resistor network according to one embodiment of the present invention, and disclose a method for manufacturing chip resistor networks with a barrier layer. The method for manufacturing chip resistor networks prevents the short circuit caused by electron migration. First, as shown in FIG. 2A, by the thick-film printing method the paired electrodes 102 are printed on an alumina substrate 100. Then, by using the thick-film printing method a plurality of resistors 104 is printed on the alumina substrate 100, and both ends of the resistors 104 are separately connected to the paired electrodes 102, as shown in FIG. 2B. A first protective layer 106 is deposited on the alumina substrate 100 and part of the electrodes 102, and the resistors 104, as shown in FIG. 2C. Referring to FIG. 2D, a barrier layer 110 is deposited on the electrodes 102 to prevent the electron-migration phenomenon, or to abate the electron-migration phenomenon. Then, laser trim is performed to adjust the resistance of the resistors 104, where a metal-exposed area is formed on the first protective layer, called laser-trimming area 107. Then, a second protective layer 108 is coated on part of the alumina substrate 100, part of the electrodes 102 and part of first protective layer 106, as shown in FIG. 2E. Then, after the substrate 100 is broken and termination electrodes are fabricated, a plurality of chip resistor networks is fabricated.

In terms of the aforementioned method for manufacturing chip resistor networks, the electrodes are silver electrodes, which has good conductivity but are easy to cause electron migration. In this embodiment, a barrier layer 110 is formed to completely cover the silver electrodes 102 to prevent the electrodes 102 from exposing on chip resistors and to prevent the electrodes 102 from electron migration. The barrier layer 110 is composed of copper or nickel, which has good conductivity and lower probability of electron migration than silver, and it can block the path that electron migration occurs. The barrier layer 110 is formed on the silver electrodes 102 by using electroplating or electroless plating, which is not intended to limit the scope. Second, the material of the first protective layer 106 and second protective layer 108 formed by thick-film printing method is insulating material, such as glass material or epoxide material.

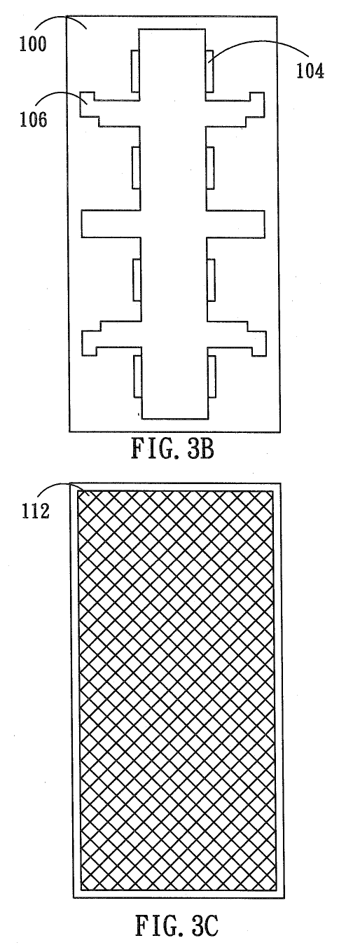

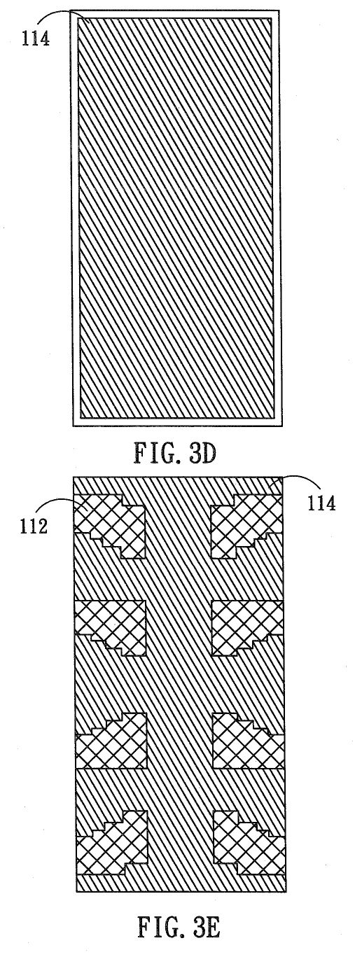

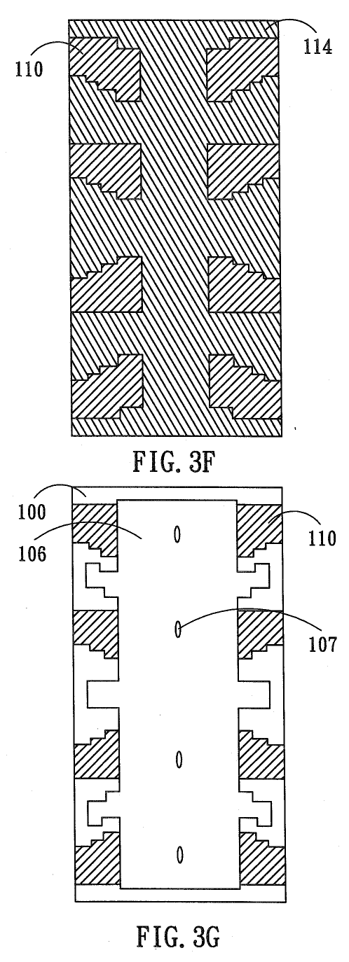

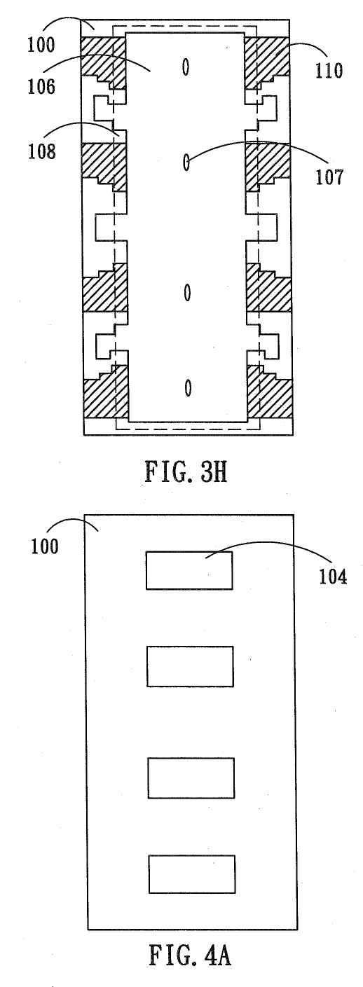

Referring to FIG. 3A to FIG. 3H, another embodiment of the present invention discloses a method for manufacturing a chip resistor network. First, a plurality of resistors 104 is printed on alumina substrate 100, as shown in FIG. 3A. Second, a first protective layer 106 is printed on the alumina substrate 100 and part of the resistors 104. The exposed areas of the resistors 104 are predetermined to be connected to the electrodes 102, as shown in FIG. 3B. Furthermore, a seed layer 112 is formed to cover the alumina substrate 100, the resistors 104 and the first protective layer 106, as shown in FIG. 3C. By photolithography technology the pattern of the electrodes 102, i.e. the predetermined electrodes-forming area, is defined as follows. First, a photoresist layer 114 is coated on the seed layer 112, as shown in FIG. 3D. Then, after exposure and development the seed layer 112 on the predetermined electrode-forming area is exposed, and the pattern of the electrodes 102 is defined, as shown in FIG. 3E.

Then, an electrode layer 110 is formed on the exposed area, the predetermined electrode-forming areas 11. The electrode layer is composed of metal materials with good conductivity and low probability of electron migration, such as copper or nickel, as shown in FIG. 3F. Next, the photoresist is removed, and the seed layer 112 where is not covered by the electrode layer 110 is etched to form the electrodes. Then, laser trim is performed to adjust the resistance of the resistors 104, and a laser-trimming area 107 is formed on the first protective layer 106, as shown in FIG. 3G. Then, a second protective layer 108 is printed to cover part of alumina substrate 100, part of the electrodes 102 and part of the first protective layer 106, as shown in FIG. 3H. Then, after the substrate 100 is broken and termination electrodes are fabricated, a plurality of chip resistor networks is produced.

Furthermore, the method for forming the seed layer is as follows. First, by sputter deposition or evaporation deposition an adhesive layer (without shown in the figure) is formed to cover the alumina substrate 100, the resistors 104 and the first protective layer 106. Then, by sputter deposition or evaporation deposition again a metal layer is formed on the adhesive layer. The seed layer 112 comprises the adhesive layer and the metal layer. The thickness of the seed layer is about 100 angstroms to 4000 angstroms. The material of the adhesive layer can be selected from Ti, Cr, TiW, NiCr, etc. The material of the metal layer is copper or nickel.

Furthermore, the material of the electrode layer formed by sputter deposition or evaporation deposition is copper or nickel, which has good conductivity and is not easy to cause electron migration during operation of chip resistor networks because of the short distance between electrodes and the existence of moisture. The thickness of the electrode layer is about 0.05 micron to 20 microns.

The embodiment of the present invention discloses a method for manufacturing chip resistor networks, wherein the silver electrodes, which have good conductivity but are easy to cause electron migration, are replaced by the electrodes, which have good conductivity but lower probability of electron migration, such as copper or nickel, etc. Therefore, it can fundamentally solve the short-circuit problem caused by electron migration between electrodes during operation of chip resistor networks.

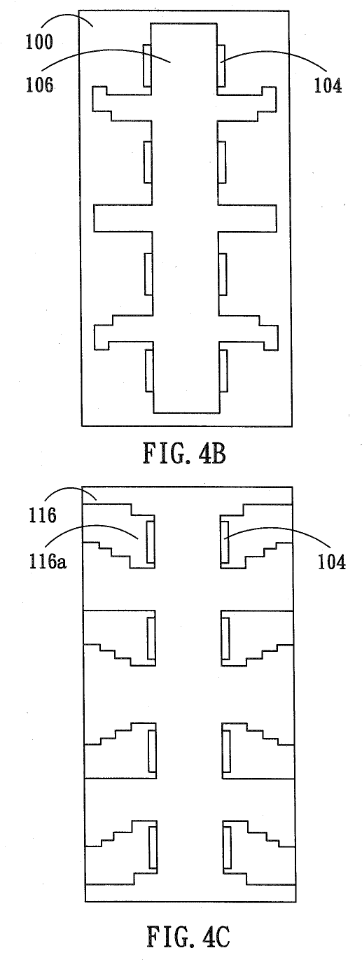

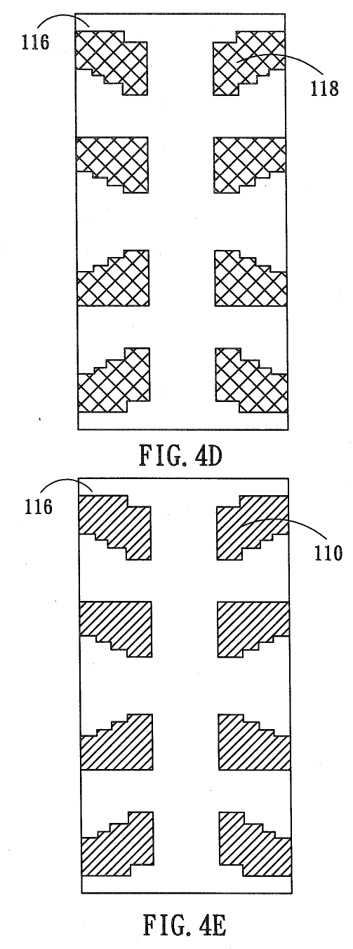

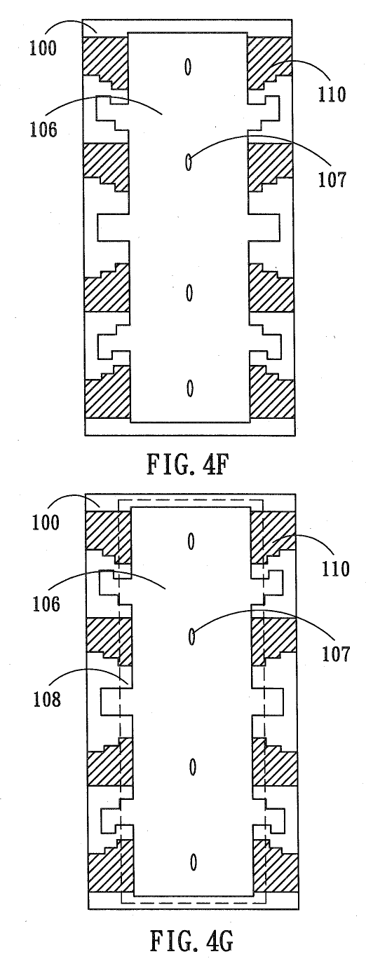

Referring to FIG. 4A to FIG. 4G, another embodiment of the present invention discloses a method for manufacturing a chip resistor network by using copper or nickel electrodes to replace the silver electrodes. First, by thick-film printing method a plurality of resistors is printed on the alumina substrate 100, as shown in FIG. 4A. By thick-film printing method a first protective layer 106 is deposited to cover part of the alumina substrate 100 and part of the resistors 104. The exposed areas of the resistors 104 are predetermined to be connected to the electrodes 102, as shown in FIG. 4B.

The terminations are covered by a patterned metal mask 116, which exposes the predetermined electrode-forming areas 106a and part of the resistors 104 which is predetermined to be connected to electrodes, as shown in FIG. 4C. An adhesive layer 118 is formed on the electrode area 116a to cover the alumina substrate 100 and part of resistors 104, as shown in FIG. 4D. Then, a metal layer, i.e. the electrode layer 110, is formed to cover the adhesive layer 118 to complete the fabrication of the electrodes 102, as shown in FIG. 4F. A second protective layer 108 is printed to cover part of the alumina substrate 100, part of the electrodes 102 and part of the first protective layer 106, as shown in FIG. 4G. Then, after the substrate 100 is broken and termination electrodes are fabricated, a plurality of chip resistor networks is produced.

In this embodiment of the present invention, the adhesive layer formed by sputter deposition or evaporation deposition is composed of metal or compound metal, such as Ti, Cr, TiW, NiCr, etc. The thickness of the adhesive layer is about 100 angstroms to 4000 angstroms. Furthermore, the electrode layer formed by sputter deposition or evaporation deposition is composed of copper or nickel, whose thickness is about 0.1 micron to 5 microns.

Furthermore, the above-mentioned first protective layer 106 and second protective layer 108 formed by thick-film printing method are composed of insulating materials, such as glass material or epoxide, which is not intended to limit the scope.

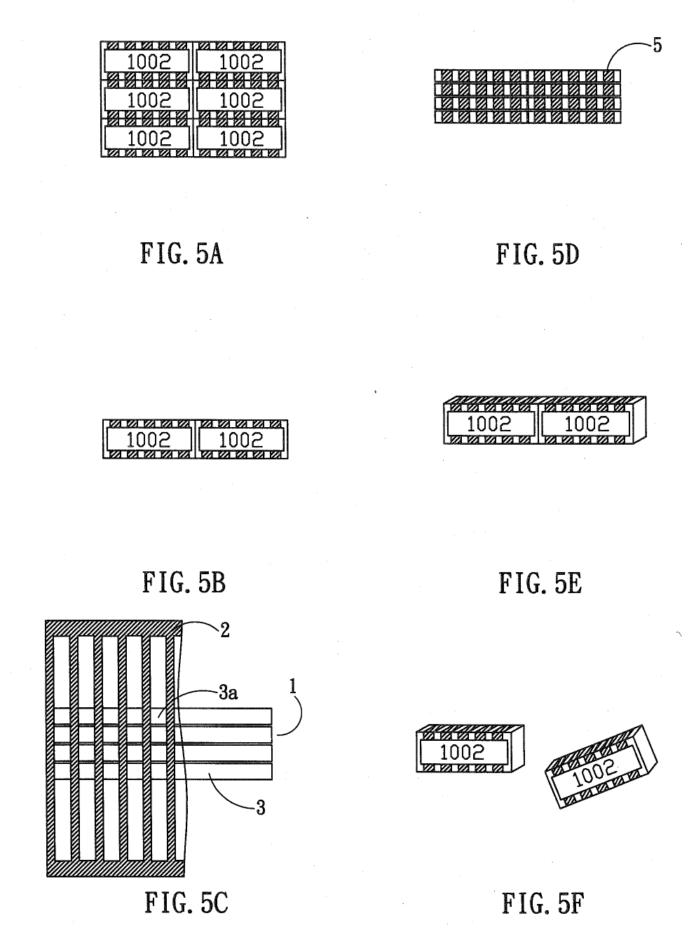

Moreover, in the present invention, during the fabrication of the termination electrodes on chip resistor networks, the terminations are covered by metal mask method, and then a seed layer is formed by sputter deposition or evaporation deposition. First, the chip resistor networks 1002 on alumina substrate are fabricated by each of the aforementioned methods, as shown in FIG. 5A. Next, after the sticks and chips cutting process by laser beam, the substrate is broken into sticks, as shown in FIG. 5B. Then, the sticks are piled to a row 1. The terminations 3 of the row 1 are covered by a metal mask with empty-engraved pattern. The predetermined termination-electrode areas 3a aligned to the empty areas of the patterned metal mask are exposed, as shown in FIG. 5C. By sputter deposition or printing method, the termination electrodes 5 are formed on the predetermined termination-electrode area 3a, and then the metal mask 2 is removed as shown in FIG. 5D. As shown in FIG. 5E, the sticks are separated. After the sticks are separated, a chip break process is carried out to break the stick substrate into a plurality of chip resistor networks, as shown in FIG. 5F. Finally, the thickness of the termination electrodes is increased by electroplating nickel or tin, and finally inspection is performed.

Although specific embodiments have been illustrated and described, it will be appreciated by those skilled in the art that various modifications may be made without departing from the scope of the present invention, which is intended to be limited solely by the appended claims.

What is claimed is:

1. A method for manufacturing chip resistor networks, comprising:
providing an alumina substrate; and
forming a plurality of resistors and a plurality of paired electrodes on said alumina substrate, both ends of said resistors connected to said paired electrodes having a barrier layer.

2. The method for manufacturing chip resistor networks according to claim 1, further comprising a step of forming a barrier layer.

3. The method for manufacturing chip resistor networks according to claim 2, further comprising forming a first protective layer to cover part of said substrate, said resistors, and part of said paired electrodes.

4. The method for manufacturing chip resistor networks according to claim 3, further comprising forming a second protective layer to cover part of said substrate, part of said first protective layer and part of said paired electrodes.

5. The method for manufacturing chip resistor networks according to claim 2, further comprising forming a first protective layer to cover part of said substrate and said resistors after formation of said resistors and before formation of said electrodes and said barrier layer.

6. The method for manufacturing chip resistor networks according to claim 5, wherein said formation step of said barrier layer further comprises forming a seed layer on said alumina substrate, said resistors, and said first protective layer.

7. The method for manufacturing chip resistor networks according to claim 6, wherein said formation step of said seed layer further comprises:
forming an adhesive layer to cover said alumina substrate, said resistors, and said first protective layer; and
forming a metal layer on said adhesive layer.

8. The method for manufacturing chip resistor networks according to claim 7, wherein formation method of said adhesive layer and formation method of said metal layer are selected from the group consisting of sputter deposition and evaporation deposition.

9. The method for manufacturing chip resistor networks according to claim 7, wherein material of said adhesive layer is selected from the group consisting of Ti, Cr, WTi, and NiCr.

10. The method for manufacturing chip resistor networks according to claim 7, wherein material of said metal layer is selected from the group consisting of copper and nickel.

11. The method for manufacturing chip resistor networks according to claim 7, wherein thickness of said seed layer is within the range of 100 angstroms to 4000 angstroms.

12. The method for manufacturing chip resistor networks according to claim 6, wherein method for forming a plurality of said paired electrodes further comprises the steps of:
coating a photoresist layer on said seed layer;
performing exposure and development process on said photoresist, wherein said photoresist is exposed and developed after patterning said photoresist by a photo-mask, and said seed layer of predetermined electrode-forming areas is exposed;
forming an electrode layer on said seed layer of said predetermined electrode-forming areas;
removing said photoresist to expose said alumina substrate, said first protective layer, said electrodes and said seed layer; and
removing said exposed seed layer.

13. The method for manufacturing chip resistor networks according to claim 12, wherein method for forming said electrode layer is selected from the group consisting of electroplating method and electroless plating method.

14. The method for manufacturing chip resistor networks according to claim 12, wherein material of said electrode layer is selected from the group consisting of copper and nickel.

15. The method for manufacturing chip resistor networks according to claim 12, wherein thickness of said electrode layer is within the range of 0.05 micron to 20 microns.

16. The method for manufacturing chip resistor networks according to claim 1, wherein said barrier layer can be said electrodes themselves.

17. The method for manufacturing chip resistor networks according to claim 16, further comprising forming a first protective layer to cover part of said substrate, said resistors, and part of said paired electrodes before barrier-layer deposition step.

18. The method for manufacturing chip resistor networks according to claim 16, wherein said method for forming said paired electrodes comprises the steps of:
covering a metal mask with empty-engraved pattern on said alumina substrate and said first protective layer, said empty-engraved areas being predetermined electrode-forming areas;
forming an adhesive layer on said predetermined electrode-forming area;
forming said electrode layer on said adhesive layer;
removing said metal mask; and
forming a second protective layer on part of said substrate, part of said protective layer and part of said paired electrodes.

19. The method for manufacturing chip resistor networks according to claim 18, wherein said adhesive layer process is selected from the group consisting of sputter deposition and evaporation deposition.

20. The method for manufacturing chip resistor networks according to claim 18, wherein process for forming said electrode layer is selected from the group consisting of sputter deposition and evaporation deposition.

21. The method for manufacturing chip resistor networks according to claim 18, wherein material of said electrode layer is selected from the group consisting of copper and nickel.

22. The method for manufacturing chip resistor networks according to claim 18, wherein thickness of said electrode layer is within range of 0.1 micron to 5 microns.

23. The method for manufacturing chip resistor networks according to claim 18, wherein material of said seed layer is selected from the group consisting of Ti, Cr, TiW, and NiCr.

24. The method for manufacturing chip resistor networks according to claim 18, wherein thickness of said seed layer is within the range of 100 angstroms to 4000 angstroms.

25. The method for manufacturing chip resistor networks according to claim 1, wherein fabrication method of said termination electrodes comprises the steps of:
performing chip-cut and stick-cut process on said alumina substrate;
performing stick-break process and piling said sticks into a row;
exposing predetermined empty space, i.e. said termination electrodes space, by metal mask method;
performing deposition process on said termination areas without shelter of metal mask by vacuum deposition method;
performing chip-break process;
electroplating;
performing inspection.

26. The method for manufacturing chip resistor networks according to claim 25, wherein said vacuum deposition method is sputter deposition.

27. The method for manufacturing chip resistor networks according to claim 25, wherein material of said metal mask is metal material.

28. The method for manufacturing chip resistor networks according to claim 25, wherein deposited material by said metal mask method is ceramic material.
